(19) United States
(12) Patent Application Publication
(10) Pub. No.: US 2011/0080674 A1
(43) Pub. Date: Apr. 7, 2011

(54) MAGNETIC AZIMUTH ADJUSTMENT FOR TONEARM

(76) Inventor: Joel Durand, Seattle, WA (US)

(21) Appl. No.: 12/572,497

(22) Filed: Oct. 2, 2009

(51) Int. Cl. G11B 21/24

(52) U.S. Cl. 360/294; G9B/21.028

(57) ABSTRACT

A tonearm includes an arm wand having a pivot location on a longitudinal axis of the tonearm. A magnetic element is coupled to the arm wand and aligned with the pivot location. The magnetic element is arranged for correcting the azimuth of the tonearm on the fly via magnetic field communication with another magnetic element.

### TECHNICAL FIELD

The present invention is directed generally to phonograph systems or the like, and in particular, but not necessarily exclusively to correcting the azimuth of tonearms in phonograph systems.

### BACKGROUND

Phonograph systems typically include a turntable, a tonearm, a pickup cartridge coupled to the tonearm, and a cantilevered stylus coupled to the pickup cartridge. The turntable rotates a phonograph record at a predetermined speed. The tonearm positions the stylus at the grooved surface of the phonograph record. The stylus mechanically tracks the peaks and valleys in the grooved surface as the record rotates. The pickup cartridge translates the mechanical tracking of the stylus into electrical signals that can be subsequently processed to produce an audio signal. In general, the electrical signal includes audio information from each side of the groove. For example, in stereo recordings, left channel information is located on one side of the groove, while right channel information is located on the opposite side.

Unfortunately, if a stylus is not properly aligned in the groove, the audio signal will not properly convey audio information, and the audio signal may be distorted. For example, in stereo applications, if the stylus deviates from true normal, it may produce left/right channel distortion. While small deviation from true normal may go unnoticed by many, trained musicians, audiophiles, and the like will often hear even small amounts of resultant distortion. Consequently, sophisticated phonograph systems allow users to adjust the angle of the stylus. This adjustment, referred to as an azimuth adjustment, can bring the stylus into true normal. However, because this adjustment typically requires a correctional force to be applied to the tonearm, it cannot be carried out while the stylus is tracking (i.e., it cannot be carried out on the fly). Rather, the tonearm is returned to a position off record so that azimuth can be adjusted. Indeed, an attempt to adjust azimuth in conventional systems could create vertical and/or lateral forces on the stylus that cause it to skip to another position in the groove. This can in turn temporarily distort an audio signal, create a discontinuity in track playback, or even scratch the record's surface.

### BRIEF DESCRIPTION OF THE DRAWINGS

FIG. 1 is an isometric drawing of an embodiment of a phonograph system.

FIGS. 2A and 2B are partial, isometric drawings of an embodiment of a tonearm assembly.

FIGS. 3A and 3B are partial, cut-away views of embodiments of pivot locations.

FIG. 4 is a partial, isometric drawing showing an embodiment of azimuth adjustment of a tonearm.

FIG. 5 is a partial, isometric drawing of an embodiment of a tonearm system.

FIG. 6 is a partial, isometric drawing of another embodiment of a tonearm system.

### DETAILED DESCRIPTION

Briefly, the invention is directed to a magnetic azimuth adjustment for tonearms, tonearm systems, and tonearm assemblies, such as those employed in phonograph systems or the like. In one embodiment, a tonearm includes an arm wand having a pivot location on a longitudinal axis of the tonearm. A magnetic element is coupled to the arm wand and aligned with the pivot location. The magnetic element is arranged for correcting the azimuth of the tonearm on the fly via magnetic field communication with another magnetic element. As used herein, the term “on the fly” refers to an adjustment of azimuth while a tonearm is tracking, for example, while the stylus of a tonearm is tracking the grooved surface of a phonograph record.

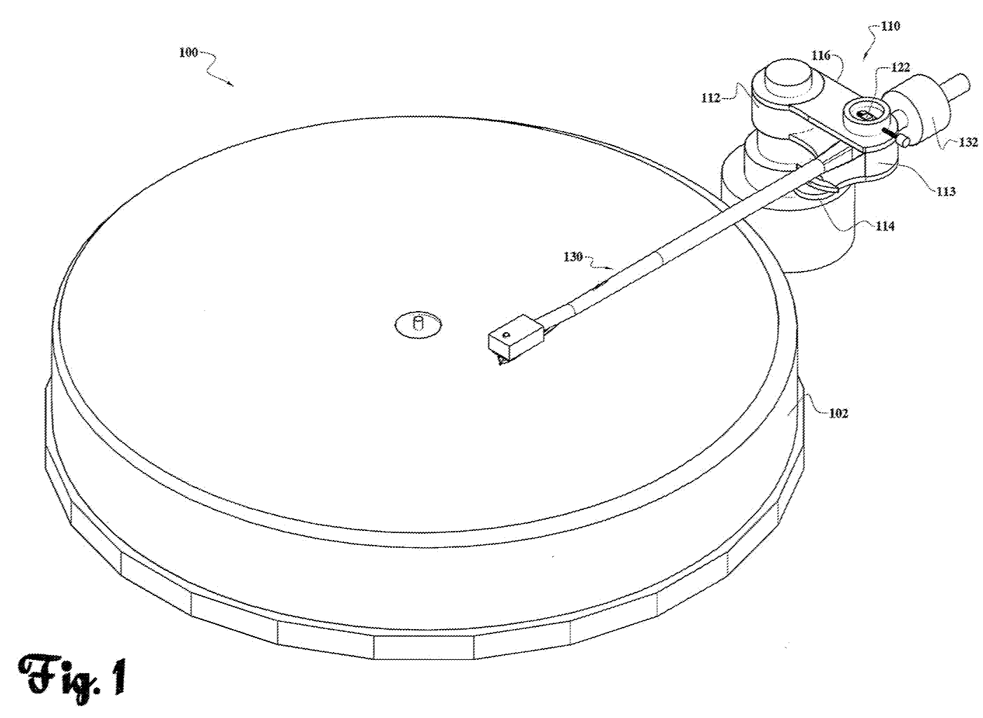

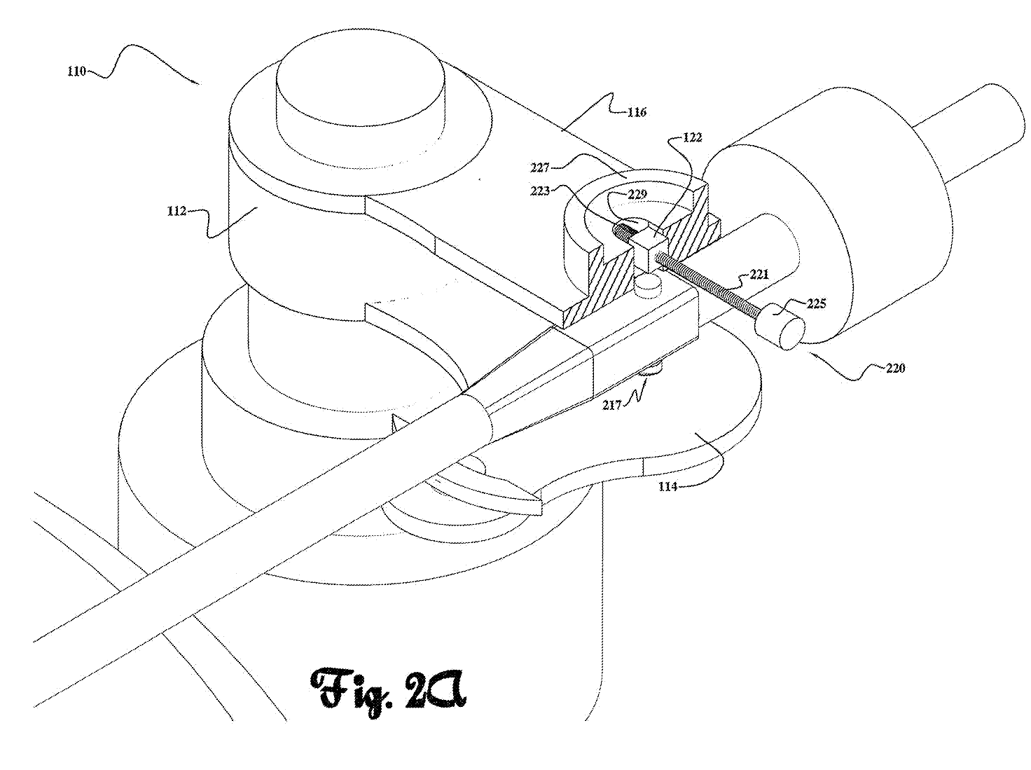

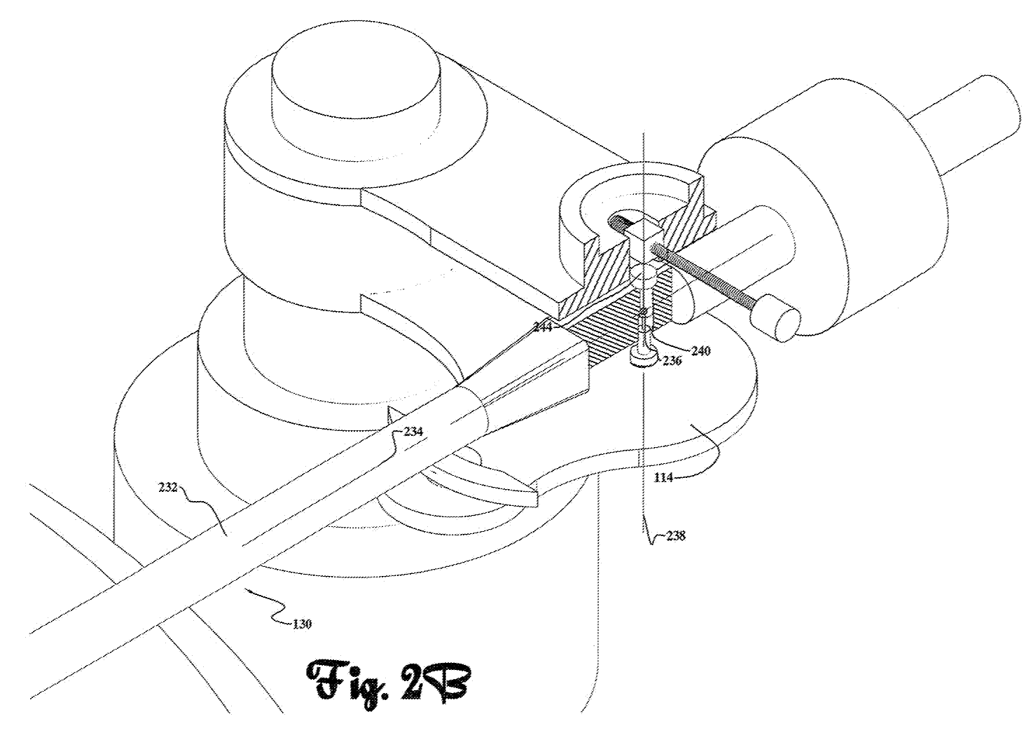

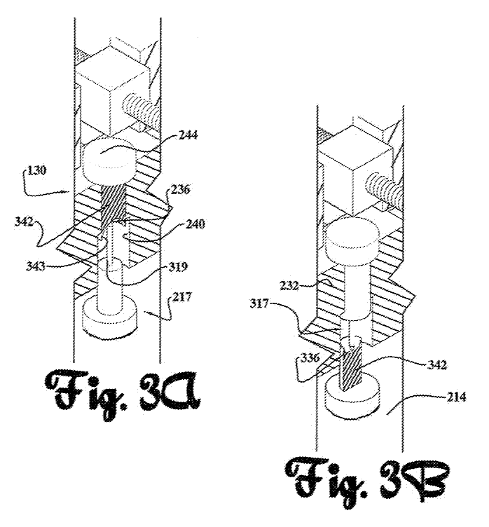

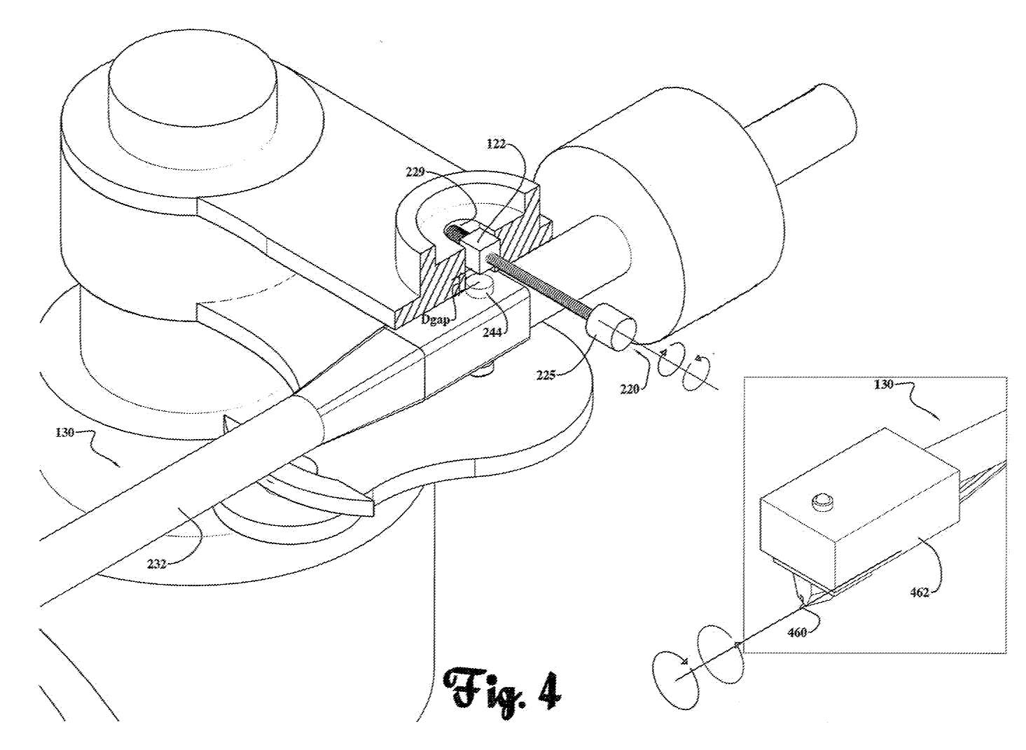

FIG. 1 is an isometric drawing of an embodiment of a phonograph system 100 in which embodiments of magnetic azimuth adjustment may be employed. The phonograph system 100 includes a platter 102 for carrying a phonograph record and a tonearm assembly 110 for tracking the groove of the record when it is mounted on the platter 102. The tonearm assembly 110 includes a support member 112, an arm stop 113, first and second arm plates 114 and 116 fixedly coupled to and projecting beyond the support member 112, and a tonearm 130. The first arm plate 114 is arranged to carry the tonearm 130 at a pivot location (not shown; described further with reference to FIGS. 2B, 3A, and 3B). The second arm plate 116 is arranged to carry a first magnetic element 122. The first magnetic element 122 is arranged to communicate via a magnetic field with a second magnetic element (not visible in FIG. 1) that is incorporated into the tonearm 130.

While not illustrated in the Figures, the phonograph system 100 can also include a variety of other components, such as a motor for rotating the platter 102 at a fixed speed, one or more controller devices for automatically or semi-automatically controlling the platter 102 and/or the operation of the tonearm assembly 110, and signal processing circuitry for producing an audio signal. Further, the tonearm assembly 110 may also include additional or alternative components not illustrated in the Figures. For example, as shown, the tonearm 130 includes a counterweight 132 for setting the tracking force of the tonearm 130. In other embodiments, however, the counterweight may be omitted or the tonearm 130 may include additional or alternative components for adjusting forces or other aspects of the tonearm, such as the lateral force the tonearm applies to a record's groove.

FIGS. 2A and 2B are partial, isometric drawings of the tonearm assembly 110 in more detail. Turning first to FIG. 2A, the tonearm assembly 110 includes a pivot element 217 coupled to the first arm plate 114 and a carriage element 220 adjustably coupling the first magnetic element 122 to the second arm plate 116. In particular, the carriage element 220 includes a screw element 221 and a retainer element 223 coupled to the first magnetic element 122 for adjusting the position of the first magnetic element 122 via an adjustment knob 225. As used herein, the term “adjustably coupled” refers to a coupling that provides for controlling or adjusting the position and/or orientation of the first magnetic element 122.

As shown in the FIG. 2A, the carriage element 220 is positioned in a cap member 227 of the second arm plate 116 and a magnet passageway 229 extending through the cap member 227. In other embodiments, however, the carriage element 220 may be positioned differently. For example, embodiments of the carriage element 220 could be integrated into the first arm plate 114, the support member 112, or the arm stop 113 (arm stop 113 is not visible in FIG. 2A). In addition, embodiments of the carriage element 220 can be orientated differently, such as vertically or obliquely. Further, while the carriage element 220 in FIG. 2A is configured to control or adjust the position of the first magnetic element 122, the carriage element 220 can be configured to control or adjust the orientation of the first magnetic element 122 and/or the position and the orientation of the first magnetic element 122.

Turning now to FIG. 2B, the tonearm 130 includes an arm wand 232 having a longitudinal axis 234, a pivot location 236 positioned on the longitudinal axis 234, and a second magnetic element 244 aligned with the pivot location 236. The arm wand 232 also includes a pivot channel 240 extending through the arm wand 232 along a transverse axis 238 of the arm wand 232.

FIG. 3A shows the pivot location 236 of the tonearm 130 in more detail. The tonearm 130 includes a bearing element 342 at least partially housed in the pivot channel 240 and coupled between the second magnetic element 244 and the pivot location 236. The bearing element 342 may include, for example, a shaft or the like that is affixed to the sidewalls of the pivot channel 240 via threads, grooves, an adhesive, or the like. In general, the bearing element 342 defines the position of the pivot location 236. For example, the pivot location 236 can be defined by the intersection of a cupped surface 343 of the bearing element 342 and a needle 319 of the pivot element 217.

In other embodiments, a pivot location may be defined differently. For example, FIG. 3B shows an alternative configuration of a pivot location 336 that is defined by a pivot element 317 and the bearing element 342, with the pivot element 317 located in the arm wand 232 and the bearing element 342 located at the first arm plate 114. Alternatively, embodiments of the pivot location may be defined by other types of pivots structures, such as a ball bearing based pivot structure or a non-uni-axial pivot structure.

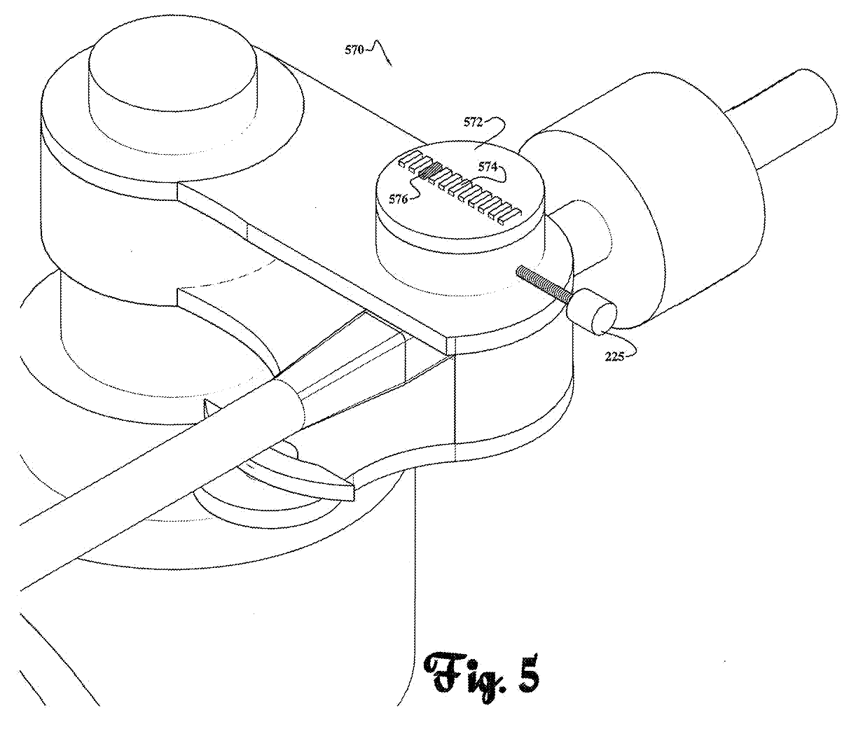

FIG. 4 is a partial, isometric drawing showing an embodiment of azimuth adjustment of the tonearm 130. In general, the control or adjustment of azimuth is achieved via rotation of the arm wand 232 that is induced by the magnetic force applied to the second magnetic element 244. When the adjustment knob 225 is rotated, it changes the position of the first magnetic element 122 in the magnet passageway 229, which in turn changes the magnetic force applied to the second magnetic element 244. For example, the inset of FIG. 4 shows a cantilevered stylus 460 at a headshell 462 of the tonearm 130 rotating clockwise when the adjustment knob 225 is rotated counter clockwise and rotating counterclockwise when the adjustment knob 225 is rotated clockwise.

FIG. 4 also shows the magnetic elements 122 and 244 being separated by a gap, Dgap. In particular, and because the magnetic elements 122 and 244 are not contacting one another, but separated by Dgap, the azimuth of the stylus can be corrected without producing lateral or vertical forces on the stylus, other than the force for azimuth correction. By contrast, conventional devices for correcting azimuth typically employ one or more mechanical devices coupled between the tone arm and a support member carrying the tone arm. For example, a gear, pulley, or the like can be a mechanical device that adjusts the azimuth of a conventional tonearm. Such a conventional azimuth adjustment, however, cannot be carried out on the fly. Indeed, even slight mechanical motion can create lateral and/or vertical forces on the tonearm. These forces can distort an audio signal, create a discontinuity in track playback, or even scratch a record's surface.

Embodiments of the tonearm 130, however, can be adjusted via magnetic field communication, such as by magnetic attraction or repulsion between the magnetic elements. Consequently, a corrective force can be applied to correct for azimuth without introducing unwanted horizontal and vertical forces on the tonearm. Also, embodiments of the tonearm 130 allow azimuth to be adjusted on the fly, without having to return a tonearm to an off-record position to adjust azimuth. Accordingly, significant trial and error time can be eliminated by allowing the tonearm to remain on-record and in a tracking state. For example, embodiments of the tonearm 130 can be used in conjunction with audio feedback from a listener to correct azimuth in real-time.

In general, the strength of the magnetic force (or magnetic field) between the magnetic elements 122 and 244 can be adjusted by changing the size of Dgap. In one embodiment, Dgap is in the range of about 0.1 to 0.3 inches. In another embodiment, Dgap is in the range of about 0.1 to 0.5 inches. Other factors, however, such as the size and the orientation of a magnetic element can influence the magnetic field strength. Also, the material or makeup of a magnetic element (e.g., permanent magnets, such as rare earth magnets or alnico magnets; ferromagnetic materials; or electromagnetic devices) can influence magnetic field strength.

In additional or alternative embodiments, the strength of the magnetic field can be adjusted by changing the orientation of a magnetic element in addition to or in lieu of changing the position of a magnetic element. For example, embodiments of the carriage element 220 can be configured to rotate a magnetic element in a magnet passageway.

In addition, embodiments of azimuth adjustment may be employed in conjunction with any of a variety of other components. For example, FIG. 5 shows an embodiment of a tonearm system 570 that employs a display component 572 of light emitting diodes (LEDs) for visually indicating the azimuth. In this embodiment, a signal processing component (not shown) can be arranged to provide an electrical signal that is indicative of azimuth and the display component 572. For example, FIG. 5 illustrates a scenario where the azimuth has a left channel bias; a center LED 574 is not illuminated, while a non-center LED 576 is illuminated. Accordingly, the adjustment knob 225 can be rotated until the center LED 574 is illuminated (and all of the other LEDS are not illuminated), indicating that azimuth has been corrected. In some embodiments, for example, music listeners might employ this type of visual feedback component if they cannot hear signal distortion due to a misaligned stylus but would nevertheless want to correct azimuth. Also, in one embodiment, the indication of azimuth may be achieved by tracking a specialized phonograph record. For example, the tonearm can be arranged to track a specialized record with identical channel information contained in each side of a record's groove. Accordingly, the indication of azimuth could be based on a disparity in the signal strength between each side of the groove.

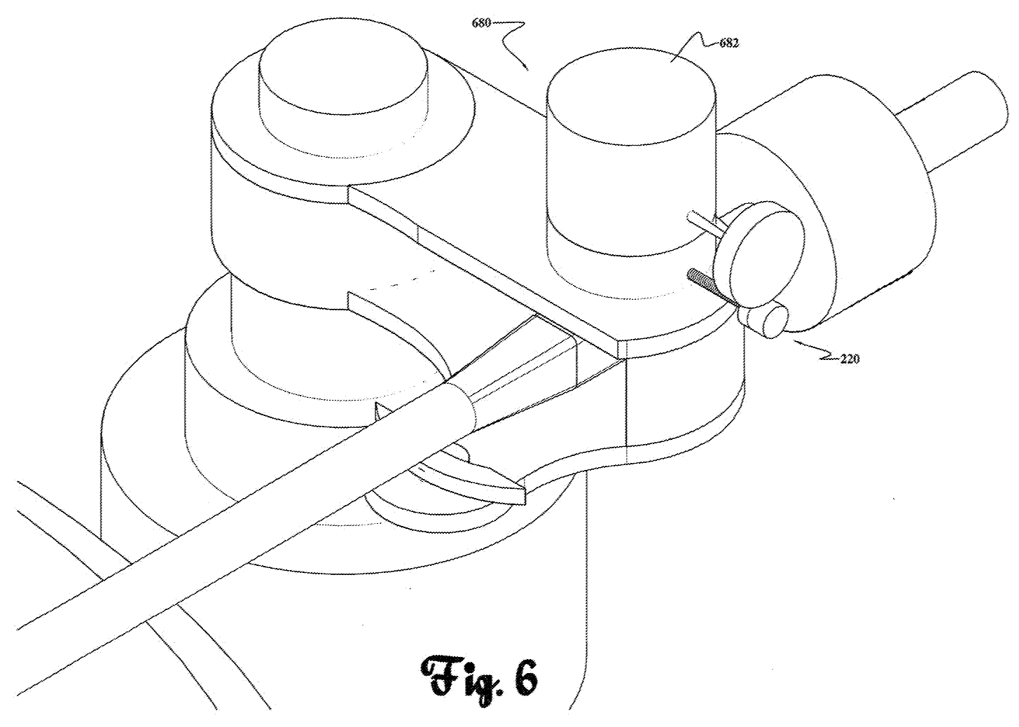

Further, embodiments of azimuth adjustment may be carried out automatically or semi-automatically. For example, FIG. 6 shows an example of a tonearm system 680 that employs a motor 682, or servo, for correcting azimuth. In particular, the motor 682 is mechanically coupled to the carriage element 220. In one embodiment, the motor 682 may be remotely controlled so that a listener could adjust azimuth from a remote location.

From the foregoing it will be appreciated that representative embodiments have been described for purposes of illustration. However, it is to be appreciated that well known characteristics often associated with tonearms, tonearm assemblies, and tonearm systems and the like have not have been described to avoid unnecessarily obscuring the various embodiments. In addition, it is to be appreciated that various modifications may be made to the various embodiments, including adding or eliminating particular features. For example, a tonearm may be directly coupled to a variety of support members, such as a vertical tracking adjustment (VTA) tower or to another component of a phonograph system. Likewise, one or more magnetic elements may be directly coupled to a variety of support members in addition to or in lieu of those described in the Figures. Also, a tonearm may include multiple magnetic elements aligned with different axis than those described in the figures or magnetic elements having different shapes, such as discs, spheres, cones, or other shapes. Further, tonearm may comprise a variety of materials, such as wood, non-magnetic metal, or carbon fiber arm wands and/or non-magnetic carriage elements, bearing elements, or pivot elements.

1. A tonearm, comprising:
an arm wand having, at least, a longitudinal axis and a pivot location on the longitudinal axis; and
a magnetic element that is coupled to the arm wand and aligned with the pivot location,
wherein the magnetic element is arranged for correcting an azimuth of the tonearm on the fly via magnetic field communication with another magnetic element.

2. The tonearm of claim 1, wherein the arm wand further includes a pivot channel and a bearing element at least partially housed in the pivot channel, and wherein the bearing element is adjacent to the pivot location.

3. The tonearm of claim 1, wherein the arm wand further includes a pivot channel and a pivot element at least partially housed in the pivot channel, and wherein the pivot element is adjacent to the pivot location.

4. The tonearm of claim 1, wherein the magnetic element includes at least one of a magnetic material or an electromagnetic device.

5. A system, comprising
an arm wand having, at least, a pivot location and being configured to carry a stylus for mechanically tracking a phonograph record;
a magnetic element coupled to the arm wand, wherein the magnetic element is aligned with the pivot location;
a support member; and
another magnetic element adjustably coupled to the support member and separated from the magnetic element by a gap, wherein the adjustable coupling is configured to provide a change in the position of the other magnetic element and/or the orientation of the other magnetic element.

6. The system of claim 5, further comprising a turntable that is arranged to carry and rotate the phonograph record.

7. The system of claim 5, wherein the size of the gap is less than about 0.5 inches.

8. The system of claim 5, further comprising a bearing element that is coupled to the arm wand between the magnetic element and the pivot location.

9. The system of claim 5, further comprising a pivot element that is coupled to the arm wand between the magnetic element and the pivot location.

10. The system of claim 5, further comprising a screw element and a retention spring that are arranged to provide the adjustable coupling of the other magnet.

11. The system of claim 5, further comprising a display component, wherein the display component is configured to provide a visual indication of an azimuth of the tonearm based, at least in part, on electronic audio signal feedback.

12. The system of claim 5, further comprising:
a carriage element coupled to the other magnetic element; and
a motor coupled to the carriage element, wherein the motor is configured to adjust, at least in part, the position of the other magnet via the carriage element.

13. A tonearm assembly, comprising:
a support member;
an arm plate fixedly coupled to the support member;
a tonearm having, at least, a pivot location and including a magnetic element coupled to the arm wand and aligned with the pivot location;
a pivot element coupled to the arm plate at the pivot location; and
another magnetic element adjustably coupled to the support member.

14. The tonearm assembly of claim 13, wherein the adjustable coupling is further configured to provide a change in the position and/or orientation of the other magnet without changing an orientation and/or position of the arm plate.

15. The tonearm assembly of claim 13, wherein the magnetic element of the tonearm and the other magnetic element are separated by a gap.

16. The tonearm assembly of claim 13, further comprising a carriage element that is configured to adjustably couple the other magnetic element to the support member.

17. The tonearm assembly of claim 13, further comprising another arm plate coupled to the support member, wherein the other arm plate is configured to carry the other magnetic element.

18. The tonearm assembly of claim 13, further comprising a counterweight coupled to the arm wand.
